(19) United States
(12) Patent Application Publication
(10) Pub. No.: US 2026/0017129 A1
(43) Pub. Date: Jan. 15, 2026

(54) Method and Support Device for Supporting Robustness Optimization for a Data Processing System, and Corresponding CI System

(71) Applicant: Bayerische Motoren Werke Aktiengesellschaft, Muenchen (DE)

(72) Inventor: Louis Hugo BREWIS, Blaustein (DE)

(21) Appl. No.: 18/993,757

(22) PCT Filed: Sep. 25, 2023
(86) PCT No.: PCT/EP2023/076406

§ 371 Date: Jan. 13, 2025

(30) Foreign Application Priority Data
Oct. 5, 2022 (DE) 10 2022 125 715.0

(51) Int. Cl. G06F 11/07; G06F 11/3668; G06N 3/126

(52) U.S. Cl. CPC G06F 11/0781; G06F 11/0784; G06F 11/3668; G06N 3/126

(57) ABSTRACT

A method and a support device for supporting robustness optimization for a data processing system and a corresponding continuous integration system are disclosed. In the method, different message sequences are generated and sent to a receiving device. For each message sequence, error alerts generated by the receiving device are then detected. Depending on the number of error alerts generated in each case, one of the message sequences is categorized as the most problematic message sequence and output as a basis for a corresponding error correction.

### BACKGROUND AND SUMMARY

The present invention relates to a method and a support device for supporting robustness optimization for a data processing system. The invention further relates to a corresponding CI system (CI: Continuous Integration).

Nowadays, an incalculable variety of software and data processing systems are employed. Such systems can assume a significant complexity, such that ensuring a robust and error-free operation thereof is potentially both difficult and complex. In light of the potential variety of error types and error sources, a corresponding variety of problem-solving approaches is already available. However, further improvements and simplifications are desirable.

By way of one approach, DE 10 2012 101 747 B4 describes a data transmission system which is intended to enable a reliable data transmission with a reduced bit error rate. In this system, both a sender and a receiver define checksums which are based upon a plurality of data frames transmitted. These checksums are then compared by a checksum comparator unit which, where applicable, signals a transmission error or can trigger a security function, in the event that the checksums compared do not match.

Nowadays, motor vehicles, which increasingly incorporate computer-based, and thus data processing-based functions, represent a key field of application. To this end, for example, EP 2 891 264 B1 describes a method for executing a safety function of a vehicle wherein, by means of a communication system, data required are transmitted to a control unit of the vehicle. In accordance with these data, the control unit generates control signals, which are transmitted to a functional unit of the vehicle which executes the safety function in accordance therewith. Diagnostic tests are executed at regular intervals, by means of which it is determined whether a fault or a malfunction is in force in an electronic and/or programmable system which is employed for the method, which might compromise the execution of the safety function. It is thus intended to enable the most reliable and securest possible execution of safety functions of a vehicle.

By way of a further example, EP 2 434 695 B1 describes a method for transmitting data between subscribers on a serial annular communication system. By this method, a data packet is transmitted from a master to a slave, and thereafter from slave to slave. Each slave modifies address information of the data packet. Each slave checks the structure of the address value and, by reference thereto, detects whether a content of the data packet is intended for the respective slave. The slave for which the data packet is intended then generates an overrun of the address value.

The object of the present invention is to enable an improved robustness of data processing systems, in a particularly efficient manner.

This object is fulfilled by the subject matter of the independent patent claims. Further potential configurations of the invention are disclosed in the sub-claims, the description and the figures. Features, advantages and potential configurations which are represented in the context of the description of any subject matter of one of the independent claims are to be considered as at least analogous to features, advantages and potential configurations of the respective subject matter of the other independent claims, and of any potential combination of the subject matter of the independent claims, optionally in association with one or more of the sub-claims.

The method according to the invention is employed for supporting a robustness optimization for a conventional bus-based data processing system. A data processing system of this type can comprise one or more software components, and one or more hardware components. Corresponding hardware components-at least in conventional use or operation—can be mutually connected by means of a data bus, i.e., a bus connection for data transmission. A plurality of components of the data processing system can be serially interconnected along a data bus or bus connection of this type. Components of this type can be, for example, control devices, controllers, embedded systems, sensors and/or similar.

Within the present meaning, robustness optimization can be employed to enable or ensure a most robust and error-free operation possible of the data processing system in its ultimately intended or productive operation or use. A robust operation can signify, for example, that the data processing system is capable of executing or fulfilling its functions as intended, i.e., in a correct manner, under different conditions or in different situations.

In the method according to the invention, a plurality of different message sequences are generated. Message sequences of this type can comprise sequences of a plurality of individual messages in a specific order. Individual messages of this type can constitute or comprise data packets, data blocks, or similar. Message sequences, or individual messages therein, can also comprise further components such as, for example, headers, time stamps and/or similar. An exact structure of message sequences can be dependent upon a respective application, i.e., upon the respective data processing system, the robustness of which it is intended to optimize. Message sequences can be generated, for example automatically or partially automatically, by means of a support device which is designed for executing the method according to the invention.

The various message sequences can be consistent and correct, in particular with respect to at least one stipulated formal criterion. In accordance with this formal criterion, message sequences can thus be compliant with a correspondingly stipulated requirement of the data processing system with respect to message sequences which are to be processed or are processable. Message sequences, or the individual messages thereof, can thus assume, for example, a stipulated data format which can be processed by the respective data processing system.

However, message sequences generated can differ with respect to one or more stipulated secondary or test criteria, or secondary or test features. Message sequences can thus be generated in a variable manner with regard to at least one stipulated test criterion or test feature, with respect to which the robustness of the data processing system is to be checked or optimized. Message sequences, for example, can be generated manually or—for example by means of a correspondingly stipulated algorithm—in a partially automatic or fully automatic manner.

Moreover, in the method according to the invention, message sequences thus generated are sequentially transmitted to a receiving device, for example also by the support device. In particular, the receiving device can be an element or a component of the respective data processing system, or can correspond to such a component. The receiving device, for example, can thus be a control device, an embedded system, a controller, or similar, for example for a motor vehicle. As message sequences are transmitted to the receiving device, and are thus communicated or input to the latter, the receiving device can also be described as a target device or target control device. In this case, message sequences can be routed to the receiving device directly or in a controlled manner, in particular directly via a corresponding interface of the receiving device or via a controlled data connection such as, for example, an ethernet connection or similar. In particular—otherwise to the ultimately intended application or employment of the receiving device or the corresponding component in the data processing system-this may not involve a bus connection with one or more components or nodes which are connected between a transmitter of message sequences and the receiving device. In this phase of the method according to the invention, variations, or unknown or uncontrolled influences from a bus connection of this type which comprises a plurality of components or interfaces, can thus be eliminated. This can ultimately generate or contribute to more accurate results.

In the present case, the receiving device is designed for receiving and processing corresponding message sequences. In principle, message sequences, with respect to the type, properties, structure, content and/or similar thereof can thus be generated in closer accordance with message sequences that the receiving device, or a corresponding component in the respective data processing system, is intended to receive and process in its ultimately intended productive employment or operation.

For each message sequence, error alerts which are respectively generated as a result thereof, i.e., upon the processing thereof by the receiving device and, for example, also by the support device, are captured. Error alerts of this type can also be received, for example, by the support device which is designed for executing the method according to the invention.

Depending upon how many error alerts are respectively generated by the receiving device as a result of message sequences processed, one of these message sequences generated which has been processed by the receiving device is classified as the most problematic message sequence, and is output as a basis for a corresponding troubleshooting, for example also by the support device.

For example, of all the message sequences which are transmitted to the receiving device and are processed by the latter, at least that message sequence or those message sequences, the processing of which by the receiving device has generated the most error alerts, can be output as the most problematic message sequence. The most problematic message sequence can thus be that or a message sequence which results in error alerts in a particularly reliable or effective manner. Faults or weak points in the receiving device can thus be identified in a particularly effective manner, and corresponding error alerts reproduced.

By reference to the message sequence which is identified as the most problematic by means of the method according to the invention, the actual identification and elimination of faults or weak points can be significantly facilitated and accelerated.

Corresponding faults or weak points can affect, for example, the robustness of the receiving device, or of a computer program or operating program which is executed therein for the processing of message sequences, or of a corresponding program code, or similar. Accordingly, this can involve faults or weak points in a computer program or operating program of this type, or in a corresponding program code, i.e., in a corresponding software of the receiving device.

By means of the support provided by the present invention, faults or weak points which are relatively rare or which assume no previously evident pattern, i.e., faults or weak points which are particularly difficult to reproduce, can be identified, understood and optionally eliminated in a particularly effective, targeted and rapid manner. This can represent a substantial advantage for the effective improvement of a robustness of corresponding functions or systems which feature a bus-based transmission of data or messages on data processing systems which at least comprise the respective receiving device. This can be considered, for example, in comparison with previous approaches in which, for example, error alerts which are randomly generated during the employment of the receiving device or of the corresponding data processing system are collated and analyzed, or it is endeavored, based on such randomly occurring error alerts, to identify a fundamental fault or a fundamental weak point. This is undertaken in consideration of relatively rare error alerts or issues, the circumstances or occurrence of which, and thus the ultimate causes thereof, are frequently unclear or difficult to identify. Moreover, particularly in the case of unreproducible or not reliably reproducible error alerts, it can simply be the case that insufficient data or error alerts are available to permit the practicable determination of a pattern, and thus of the ultimate cause.

An effective improvement of the robustness of data processing systems which is thus enabled by the present invention, depending upon the application, can generate or contribute, for example, to improved security, reduced costs, the more rapid execution of tasks and/or similar.

In one potential configuration of the present invention, a plurality of or all the message sequences generated contain the same individual messages. This arrangement can correspond, for example, to a formal criterion which is specified elsewhere. In the configuration of the present invention proposed here, however, the message sequences generated vary with respect to the time intervals between these individual messages. In this case, these different time intervals between individual messages can correspond to a search or test criterion or feature which is specified elsewhere. In this case, the different message sequences can thus comprise the same content, which content, however, can assume different timings. Depending upon the application, individual messages in all the message sequences generated can thus be arranged in the same sequence. As a result, in a particularly specific or targeted manner, faults or weak points can be identified which are attributable to, or susceptibly associated with timing variations, i.e., differences or deviations in the time intervals between individual messages within a message sequence.

Additionally or alternatively, message sequences, or a second set of message sequences can be generated having varied, i.e., different orders of individual messages. For message sequences of this type, having different orders of individual messages, uniform timings, i.e., the same time intervals, or the same pattern of intervals or interval sequences between individual messages, can be employed. Thus, in a particularly specific or targeted manner, faults or weak points can be identified which are attributable to, or susceptibly associated with deviations in the order of individual messages.

Message sequences, or a set of message sequences can also be generated having both varied timings and varied orders of individual messages. Diverse or complex faults or weak points, which only occur in conjunction with, or are relevant to a combination of specific timings and sequences of individual messages can thus be identified wherein, in response to corresponding message sequences, corresponding error alerts are generated or triggered.

The variation of timings within message sequences proposed herein can be particularly expedient for triggering unforeseen, randomly occurring and/or relatively rare or typically difficultly reproducible error alerts. In practical applications, for example, unforeseen combinations of multiple factors, which may optionally lie outside a direct functional or operating scope of the receiving device, can result in timing variations. This can be dependent, for example, upon relative scanning or computing frequencies, or corresponding phase relations in various components of the data processing system, and/or upon different capacity utilizations and/or different levels of fullness of a buffer memory or cache memory and/or similar. In practice, as a consequence of such effects, individual messages in a message sequence, for example, can be captured, processed and/or relayed via the data bus to the receiving device with varying speed.

In a further potential configuration of the present invention, a multiple transmission of each message sequence to the receiving device is executed. In each case, all error alerts arising are considered for the determination of the most problematic message sequence. In other words, a plurality of entities can transmit each of the message sequences to the receiving device for the processing thereof by the latter. For example, error alerts generated for, or associated with a message sequence for all entities can then be numbered, i.e. totalized or cumulatively consolidated. The corresponding cumulative error alerts of all entities for a specific message sequence, or the number thereof, can then be assigned to the respective message sequence. These corresponding cumulative numbers of error alerts for all message sequences can then be mutually compared. However, for example, a mean or median value of numbers of error alerts generated by, or associated with the processing of a message sequences for multiple entities can also be formed and employed as a corresponding comparative value. Accordingly, that message sequence for which the largest corresponding mean value has been determined can be output as the most problematic message sequence, or the message sequence, the processing of which by the receiving device has generated the most error alerts.

By means of the multiple transmission and processing of message sequences proposed herein, effects or influences which affect robustness, or corresponding faults or weak points, can be identified in a particularly reliable manner. The occurrence of error alerts can thus be dependent, for example, upon a respective reception time of a message sequence or of an individual message, for example in relation to a point or phase in a clock cycle of the receiving device and/or to a level of fullness of an input buffer memory or cache memory of the receiving device which, for example, will only be entirely filled by a plurality of message sequences, and/or similar. In the multiple transmission of a message sequence, the corresponding individual entities of the message sequence, for example at least in part, can execute transmission to the receiving device in a directly sequential manner, or with differing mutual time intervals. As a result, faults or weak points based thereupon or associated therewith can be located in a particularly simple manner, or identified in a correspondingly simple and reliable manner. This can ultimately result in, or contribute to a further improvement in the robustness of the receiving device or of the corresponding data processing system.

In a further potential configuration of the present invention, the various message sequences are generated by means of a predefined genetic algorithm. In the context of this genetic algorithm, in particular, pairings and mutations can be employed across multiple generations to generate varied message sequences. For a respective user, a genetic algorithm of this type, in a particularly simple and uncomplex, and thus in a particularly reliable manner, can generate message sequences which generate a particularly large number of error alerts, or which result in the generation of at least one error alert in a particularly reliable manner. By means of the genetic algorithm, for example, properties of message sequences which ultimately result in error alerts can be automatically amplified or sustained, or can ultimately be accumulated or concentrated in the most problematic message sequence. This can proceed independently of whether the properties or corresponding values of a specific property which are responsible, in practice, for an error alert on the receiving device are known or otherwise by the respective user or operator. By means of the application of the genetic algorithm proposed herein, problematic message sequences, i.e., those which, in a particularly frequent or reliable manner, result in error alerts, can optionally be generated or identified more reliably and/or more rapidly, or with lower overall complexity, than in the case, for example, of an exclusively random generation of different message sequences, or a generation and processing—which is scarcely feasible in practice—of all the different message sequences possible.

In a potential further development of the present invention, in or by means of the genetic algorithm, by way of a respective gene sequence of message sequences, a respective series of time intervals between individual messages contained in the respective message sequence. In other words, the timings specified elsewhere can be employed for the variation of message sequences. A time interval between two sequential individual messages in a specific message sequence can thus form a gene of this message sequence. In particular, the individual messages, or the order thereof, can thus be identical for all message sequences. In the present case, gene sequences of message sequences can be respectively represented, for example, by a simple numerical sequence, wherein each number can indicate the time interval between two sequential individual messages. Gene sequences can thus be administered or processed in a particularly uncomplex manner on the grounds that, for example, for the description of a message by its gene sequence, no indication or processing of the actual data content of the respective message sequence is required.

In a potential further development of the present invention, in or by means of the genetic algorithm, as a measure of the fitness of message sequences, the number and/or severity and/or type of error alerts generated in the processing thereof by the receiving device is/are employed. A greater number and/or a greater severity of error alerts and/or a hierarchically higher classification according to a predefined hierarchy, ranking list or order of error alert types, i.e. a correspondingly prioritized or prioritizable type of error alerts, thus corresponds to a greater fitness. For the severity of error alerts, a corresponding hierarchy, ranking list or order can likewise be stipulated, in which different types or properties or impacts of error alerts can be indicated by sorting in a stipulated manner. It can thus be provided that, as a feature or criterion for the further employment of a message sequence in the next respective generation, i.e. for the crossover of the message sequence in the context of the genetic algorithm, a greater number or severity of error alerts, or a hierarchically higher classification in the hierarchy or ranking of error alert types, is critical.

These features or criteria can be employed individually or in mutual combination. Thus, for example, if two different message sequences generate an equal number of error alerts wherein, however, one message sequence results in more severe, or higher hierarchically classified error alerts, this message sequence can assume a greater fitness and is correspondingly preferred for further use, for example by the assumption or incorporation thereof in the next generation of message sequences.

By means of the configuration of the present invention proposed herein, a message sequence which results in particularly significant or relevant faults can ultimately be determined in a particularly reliable manner. This can enable an optimization of the robustness of the respective data processing system, with a prioritized processing or consideration of particularly severe and/or relevant faults or weak points. Thus, for example, a less severe fault can result in an unexpected delay, without disturbing or disabling the fundamental functions of the receiving device or data processing system. A more severe error or a more severe weak point, conversely, can result in a safety-relevant malfunction or in a hard termination or interruption of a function, of an execution of a program, or similar. Thus, by means of the configuration of the present invention proposed herein, by a corresponding prioritization of error alerts, a correspondingly prioritized optimization can be enabled and thus, ultimately, a particularly efficient and effectively improved security and/or reliability of the data processing system can be achieved.

In a potential further development of the present invention, the production by the genetic algorithm of new generations, i.e., of newly varied message sequences, continues until such time as a predefined convergence criterion with respect to error alerts and/or with respect to the fittest message sequence and/or a predefined interruption criterion is/are fulfilled. The genetic algorithm or the production of new generations or individuals, and thus of new message sequences, is then automatically interrupted if the convergence criterion and/or the interruption criterion, for example whichever is the earlier, is fulfilled. In the context of the convergence criterion, for example, a convergence of message sequences or of the properties of message sequences with a particularly problematic message sequence, a corresponding property or a corresponding set of properties, or at least with a cluster of problematic message sequences having identical or similar properties, can be checked. It can thus be determined, for example, whether message sequences executed in the genetic algorithm, and which are thus the fittest according to the stipulated measure of fitness, will remain at least substantially unchanged over multiple generations.

A corresponding cluster, i.e., a grouping of message sequences and/or of properties of message sequences, can be generated or identified, for example, in a corresponding abstract vector or feature space. To this end, a cluster analysis can be employed. The convergence criterion can then be fulfilled, for example, in the event that, over a stipulated number of generations, the fittest message sequence, or the property or properties thereof, lie or remain within a corresponding cluster. Optionally, multiple clusters formed over multiple generations can also be detected. Multiple parallel clusters can assume different faults or weak points. Optionally, these can then be identified separately from one another, and optionally eliminated.

As a convergence criterion or relevance criterion for a cluster, for example, a stipulated minimum size or a stipulated minimum number of error alerts and/or message sequences in a cluster can be employed or considered. A cluster will then only be recognized as such, or as relevant, in the event that it achieves the stipulated minimum size, and thus—for example within a stipulated maximum distance from one another—contains, comprises or represents at least the stipulated minimum number of message sequences and/or error alerts. The corresponding distance can be determined, for example, by means of an abstract distance criterion, for example in the form of a Mahalanobis distance, or similar. By means of the configuration of the present invention proposed herein, complexity associated with the execution of the method according to the invention can be restricted or prescribed. As a result, the method according to the invention can be applied in a correspondingly effective and efficient manner. By means of the proposed cluster analysis, moreover, a plurality of different faults or weak points can be identified simultaneously. This can also contribute to an improved efficiency of robustness optimization.

In a further potential configuration of the present invention—for example, additionally to the respective number of error alerts—a type and/or severity of error alerts, or of the fundamental fault responsible for the latter, can also be captured. The respective type and/or severity of error alerts is then considered in combination with the respective number of error alerts, for the determination of the most problematic message sequence. To this end, for example, error alerts can be weighted according to their type and/or severity, or in consideration thereof. To this end, for example, the hierarchy, ranking list or order of error alerts or error alert types specified elsewhere can be employed or established as a basis in each case. Thus, for example, at least in mathematical terms, a more severe or, according to type, a hierarchically higher ranked or higher priority error alert can be counted as more than one error alert, or otherwise incorporated to a greater extent in the determination of the most problematic message sequence than a less severe or, according to type, a non-priority or lower priority error alert. This represents a simple and practicable option for the customized prioritization of faults or weak points, according to respective requirements.

The present invention further relates to a support device for supporting robustness optimization, in particular for the intended operation of a bus-based data processing system. The support device according to the invention comprises a process device, i.e. for example, a microchip, microprocessor, microcontroller or similar, and a computer-readable data memory which is connected thereto. The support device according to the invention further comprises at least one interface for transmitting message sequences to a receiving device and for the reception of resulting error alerts from the or a receiving device. The support device according to the invention is designed, in particular, for the automatic or partially automatic execution of the method according to the invention. To this end, for example, a corresponding operating or computer program, which encodes or implements the process steps, sequences or measures specified in conjunction with the method according to the invention, can be saved in the data memory. This operating or computer program is then executable by means of the process device, to enact the execution of the corresponding method. The support device according to the invention, in particular, can be support device specified in conjunction with the method according to the invention, or can correspond thereto.

The present invention further relates to a CI system for continuous software integration. The CI system according to the invention comprises a support device according to the invention. The CI system is thus designed, by means of the support device, and thus by the application of the method according to the invention, to automatically check introduced or captured software components, i.e. for example, corresponding program code, for errors, susceptibility to errors or robustness. To this end, different message sequences can thus be automatically generated by the support device and transmitted as input to the respectively introduced or captured software components, or to the respective program code, for processing. The CI system can also be designed, using the respectively introduced or captured software components or the respective program code, to update a predefined test version of a more comprehensive software which is saved, for example, in a data memory of the CI system, and/or a receiving device or data processing system which, in its intended application, is connected to the CI system, and to transmit message sequences thus generated to this software and/or to this receiving device. Resulting error alerts can then be automatically captured by the support device.

The CI system according to the invention is further designed, in the event that no error alert is generated or captured during checking, to release the respective software components for integration and thus, for example, to execute the delivery and/or automatic integration thereof in a corresponding productive system.

The CI system according to the invention is further designed, in the event that at least one error alert is generated or captured during checking, to reject the respective software component and to automatically generate a corresponding report. A report of this type can also include the respectively identified most problematic message sequence, for example together with the corresponding error alerts. The respective report can be saved, for example, in a data memory of the CI system and/or output via a corresponding interface and/or transmitted in the form of an E-mail or similar, and/or similarly otherwise. By means of the CI system according to the invention, a continuous software integration can thus be implemented or executed in a particularly secure and reliable manner.

The CI system according to the invention can also be designed to save the respectively identified most problematic message sequence for a rejected software component, for example in association with an associated classification or identification. This message sequence, in the event that, for example, a new version or revision of the respective software component is introduced or captured, can then be employed for the checking thereof. For example, the respective previously determined most problematic message sequence can be employed as the first message sequence for checking the new software components or the correspondingly updated software. Optionally, the respective message sequence can also be employed as a starting point for the generation of further message sequences and/or as at least one part of a first generation for the genetic algorithm described in conjunction with the method according to the invention. The CI system can thus be designed, in response to a rejection of a software component, to automatically generate a new or future release test, particularly according to the respective most problematic message sequence or according to a pattern of message sequence properties and/or error alerts thus identified. Corresponding enablement or release tests can thus be at least partially automated, and continuous software integration can thus be implemented or executed, not only in a particularly secure and robust manner, but also in a particularly efficient manner.

The CI system according to the invention can also be a CD system (CD: Continuous Delivery) or part of a CD system.

Further features of the invention may proceed from the claims, the figures and the description of the figures. Features and combinations of features specified in the preceding description, and features or combinations of features disclosed hereinafter in the description of the figures, or in the figures alone, are not only applicable in the respectively indicated combination, but also in other combinations or in isolation, without departing from the scope of the invention.

### BRIEF DESCRIPTION OF THE DRAWINGS

FIG. 1 shows an exemplary schematic representation of a message sequence for a data processing system;

FIG. 2 shows a schematic representation, illustrating a generation of different message sequences by means of a genetic algorithm; and

FIG. 3 shows an exemplary schematic illustrative overview of a CI system with integrated robustness optimization.

### DETAILED DESCRIPTION OF THE DRAWINGS

In the figures, identical and functionally equivalent elements are identified by the same reference symbols. In the interests of clarity, in the multiple presence of identical or equivalent elements, only a proportion or a representative selection thereof are explicitly represented.

One example of a software or data processing application in which, for safety reasons, it is intended that errors should be prevented insofar as possible, is the determination and output of a locally permissible maximum speed by a corresponding assistance system of a motor vehicle. An assistance system of this type, for determining the permissible maximum speed, for example, can receive and process map data in a corresponding control device. Map data of this type can be transmitted, for example, from a navigation device via a data bus, and thus in the form of bus messages, to the control device. The ADAS protocol, for example, can be employed for this purpose. However, this protocol can be susceptible or sensitive both to errors or unexpected deviations or variations in the timing of corresponding messages, and thus of corresponding data packets or similar, and to the sequence of messages or data packets. Immediately such errors or deviations occur, it can be possible that the control device does not correctly process the corresponding message or, optionally, the corresponding messages and, accordingly, outputs an error alert (see FIG. 3), in particular via the data bus.

However, ultimately responsible fundamental faults or weak points, for example in a corresponding source code of the control device, can be difficult and complex to identify. To facilitate this identification, an at least partially automated support, for example based upon a predefined genetic algorithm, can be employed.

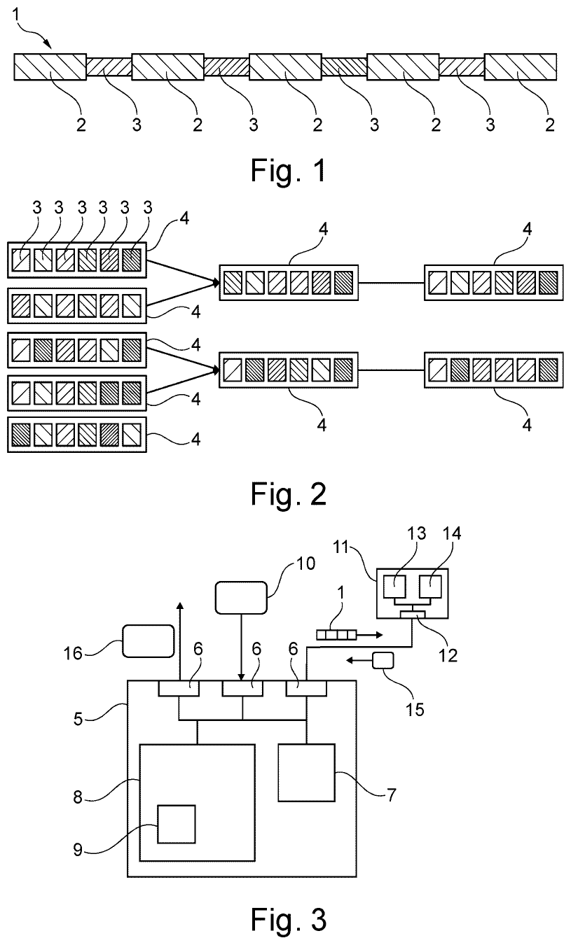

A genetic algorithm of this type can generate different messages, which can then be transmitted to the control device to check whether error alerts 15 will occur as a result. FIG. 1 shows an exemplary schematic representation of a corresponding message sequence 1. In this case, the message sequence 1 comprises a plurality of individual messages 2, each having a time interval 3 therebetween. The individual messages 2 can be, for example, signals or data blocks for various functions and/or devices, which are intended to be transmitted in a stipulated order and at specific mutual time intervals 3 via the data bus. However, in corresponding control device landscapes, which comprise multiple control devices or other devices such as, for example, sensors or similar, which are interconnected by means of a data bus and which communicate by way of error-sensitive bus messages, it can be problematic to identify faults or weak points in the processing of these bus messages. This can be dictated by the fact that, in many cases, timing issues, for example, different time intervals 3 between the individual messages 2 can occur, which may be difficult to identify and reproduce.

In this case, time intervals 3 in the message sequence 1 can thus be differentiated or varied, and ultimately, by means of the genetic algorithm, a multiplicity of such message sequences 1 having differently varying time intervals 3 between the individual messages 2 can be generated. The message sequences 1 can be described by a respective gene sequence, which can be determined or defined by the respective order of time intervals 3 in the respective message sequence 1.

By way of further illustration, FIG. 2 shows an exemplary schematic overview of a plurality of corresponding individuals 4, to which the genetic algorithm can be applied. In this case, the individuals 4 are defined by their gene sequences, i.e., by a respective order of intervals 3. A commonality between two individuals 4 can occur, for example, wherein the same time interval 3 is present at the same position in the respective gene sequence. However, all the message sequences 1 corresponding to the individuals 4, with respect to at least one stipulated formal criterion, can be identical and correct, i.e., for example, will comprise all the individual messages 2 anticipated in the respective application in a stipulated and correct order. Accordingly, for example, the individuals 4 can thus assume the same number of genes, and thus of individual intervals 3.

In the context of the genetic algorithm, various individuals 4 can be mutually combined and—for example random—mutations, i.e. variations of one or more intervals 3 in an individual 4 can be generated. To distinguish between weak and fit individuals 4, a respective measure of fitness or a respective fitness can be defined for each individual 4. To this end, for example, using the gene sequence of each individual 4, the corresponding message sequence 1 can be generated and transmitted to the control device, in a multiple sequential manner. Resulting error alerts 15, i.e. those generated by the processing of the respective message sequence 1 by the control device, can then be captured. Based on these error alerts 15, the number or type and/or severity thereof, the measure of fitness or the fitness of the respective message sequence 1, and thus of the corresponding individual 4 with respect to the genetic algorithm can be determined.

Based on their respective fitness, fit or, relative to other individuals 4, fitter individuals 4, or the genes thereof in gene pairings, can be preferred over weaker, and thus less fit individuals 4. By means of such pairing and, optionally, mutations, i.e. alterations in individual intervals 3, a new generation of individuals 4 can be generated by means of the genetic algorithm. Message sequences 1 corresponding to these individuals 4 in the respective new generation can also be transmitted to the control device, to permit the capture of resulting error alerts 15 and, on the basis thereof, to determine the respective fitness of individuals 4 in the new generation. For example, as a starting basis, 100 different individuals 4 can firstly be generated, each of which can then be transmitted 10 times to the control device. Depending upon the application however, other values can also be employed for this purpose. On the basis thereof, for example, the genetic algorithm can then be applied until such time as a convergence on a specific individual 4 or on a cluster of individuals 4 occurs, whereby, for example, in a particularly reliable manner, particularly numerous and/or severe error alerts 15 can be generated or initiated.

For the further illustration of the application of a genetic algorithm of this type for the robustness optimization of a data processing system, FIG. 3 represents an exemplary schematic overview of a CI system 5. In this case, in a schematic illustration, the CI system 5 comprises one or more interfaces 6, a processor 7 and a data memory 8. In this data memory 8, for example, a corresponding test program 9 can be saved, which comprises or implements the genetic algorithm. Naturally, further data, software components, computer programs and/or similar can be saved in the data memory 8.

The CI system 5, for example, can capture a candidate software component 10 via the interface 6. Candidate software components 10 can be, for example, new or updated software code, which is incorporated in a software which is managed by the CI system 5 or in a corresponding data processing system. Rather than the direct execution thereof, however, this candidate software component 10 can firstly be tested in the manner described. To this end, for example, the candidate software component 10 can firstly be run on a stipulated test device 11. The test device 11 for this purpose can comprise, for example, a test device interface 12, a test device processor 13 and a test device data memory 14. The test device 11 can correspond, for example, to the above-mentioned control device.

For example, the test device 11 can be connected to the CI system 5 via an ethernet connection. By means thereof, the CI system 5 can transmit different message sequences 1 which are generated by means of the genetic algorithm for processing on the test device 11, for example using the SOME/IP protocol, or similar. Any resulting error alerts 15 can be captured by the CI system 5 and considered by the test program 9, as described. Accordingly, the test program 9, for example on the basis of error alerts 15 thus captured, can adjust timings, i.e., the intervals 3 in the message sequences 1. This can be continued until such time as an ultimate problematic individual 4 or a corresponding message sequence 1, or an ultimate error pattern has been identified.

Depending upon the outcome of the test program 9, and thus upon the application of the genetic algorithm, the CI system 5 can generate a corresponding output 16. If no error alerts 15 have been captured, the output 16 can comprise, for example, those candidate software components 10 which, for example, qualify for release or incorporation accordingly. Conversely, if error alerts 15 have been captured, for example, a corresponding message or report can be delivered by way of the output 16. Thus, for example, the candidate software component 10, the most problematic message sequence 1 identified by means of the test program 9, and the error alerts 15 generated by the processing of this message sequence 1 on the test device 11 can be indicated or output. An output of this type 16 can support an analysis of fundamental faults or weak points in the test device 11, for example wherein a corresponding problem can be deliberately reproduced, for example in a computer-supported debugging environment, or similar.

Overall, the examples described illustrate how a method can be embodied for identifying faults or weak points such as, for example, timing issues, in systems which deliver feedback, for example in the form of error alerts 15, by the processing of messages, thereby facilitating the analysis of corresponding source code and, for the ultimate improvement of robustness, eliminating the corresponding malfunction, for example in embedded systems, control devices or similar. Thus, for example, by means of a genetic algorithm, timing-based faults in sequence-dependent and bus-based data processing systems can be identified.

### LIST OF REFERENCE NUMBERS

1 Message sequence
2 Individual messages
3 Interval
4 Individual
5 CI system
6 Interface
7 Processor
8 Data memory
9 Test program

Candidate software component
11 Test device
12 Test device interface
13 Test device processor
14 Test device data memory
15 Error alerts
16 Output

1-10. (canceled)

11. A method for supporting a robustness optimization for a bus-based data processing system, the method comprising:
generating a plurality of message sequences;
sequentially transmitting the message sequences to a receiving device, which is configured to process the message sequences;
capturing, for each message sequence, error alerts which are respectively generated upon processing of the message sequences by the receiving device; and
depending upon how many of the error alerts are generated, classifying one of the message sequences as a most problematic message sequence, and outputting the most problematic message sequence as a basis for a corresponding troubleshooting.

12. The method of claim 11, wherein the message sequences contain same individual messages, but vary with respect to time intervals between each message sequence.

13. The method according to claim 11, wherein each message sequence is transmitted to the receiving device a plurality of times and, in each case, all of the error alerts are considered for determination of the most problematic message sequence.

14. The method according to claim 11, wherein the message sequences are generated by a predefined genetic algorithm, including pairings and mutations across multiple generations.

15. The method according to claim 14, wherein, in the genetic algorithm, by way of a respective gene sequence of the message sequences, a respective series of time intervals between individual messages contained in the message sequences is employed.

16. The method according to claim 14, wherein, in the genetic algorithm, as a measure of fitness of the message sequences, a number and/or severity and/or type of the error alerts generated in processing of the message sequences is/are employed, wherein a greater number and/or a greater severity of the error alerts and/or a hierarchically higher classification of the error alerts, according to a predefined hierarchy of error alert types, corresponds to a greater fitness.

17. The method according to claim 15, wherein, in the genetic algorithm, as a measure of fitness of the message sequences, a number and/or severity and/or type of the error alerts generated in processing of the message sequences is/are employed, wherein a greater number and/or a greater severity of the error alerts and/or a hierarchically higher classification of the error alerts, according to a predefined hierarchy of error alert types, corresponds to a greater fitness.

18. The method according to claim 14, wherein production of new message sequences by the genetic algorithm continues until such time as a predefined convergence criterion with respect to the error alerts and/or with respect to a fittest message sequence and/or a predefined interruption criterion is/are fulfilled.

19. The method according to claim 15, wherein production of new message sequences by the genetic algorithm continues until such time as a predefined convergence criterion with respect to the error alerts and/or with respect to a fittest message sequence and/or a predefined interruption criterion is/are fulfilled.

20. The method according to claim 16, wherein production of new message sequences by the genetic algorithm continues until such time as a predefined convergence criterion with respect to the error alerts and/or with respect to a fittest message sequence and/or a predefined interruption criterion is/are fulfilled.

21. The method according to claim 11, wherein a type and/or severity of the error alerts is also captured and considered in combination with a number of the error alerts for determination of the most problematic message sequence.

22. A support device for supporting a robustness optimization for a data processing system, comprising a processor device and a non-transitory computer-readable data memory which is connected thereto, and at least one interface for transmitting message sequences to a receiving device and for receiving error alerts from the receiving device, wherein the support device is configured to execute a method according to claim 11.

23. A continuous integration system for continuous software integration, which comprises a support device according to claim 22, and which is configured to:
automatically check, by the support device, introduced software components for susceptibility to errors,
in an event that no error alert is captured during checking, release a respective software component for integration;
in an event that at least one error alert is captured during checking, reject the respective software component and to automatically generate and output a corresponding report, which also includes a most problematic message sequence identified by the support device.
